(19) United States
(12) Patent Application Publication
(10) Pub. No.: US 2006/0069565 A1
(43) Pub. Date: Mar. 30, 2006

(54) Compressed data processing apparatus and method and compressed data processing program

(76) Inventor: Hiroyuki Hiraishi, Tokyo (JP)

Correspondence Address: DELLETT & WALTERS, P. O. BOX 82788, PORTLAND, OR, 97282-0788, US

(21) Appl. No.: 10/507,266

(22) PCT Filed: Mar. 13, 2003
(86) PCT No.: PCT/JP03/02982

§ 371 Date: Jul. 21, 2005

(30) Foreign Application Priority Data
Mar. 13, 2002 (JP) 2002-067794

(51) Int. Cl. G10L 13/00

(52) U.S. Cl. 704/258

(57) ABSTRACT

A compressed data processing apparatus, a method thereof and a compressed data processing program that are capable of reducing a processing load and enhancing processing speed. A multitrack decompression apparatus 30 comprises compressed audio data read-in section 31, decompression processing sections 34, 35, and 37, and synthesis processing section 36. When two pieces of compressed audio data in MPEG-1 audio format are read-in by the compressed audio data read-in section 31, sectional decompression processing up to a step of inverse quantization processing is performed for each piece of data by decompression processing sections 34 and 35. Synthesis processing is performed by synthesis processing section 36 for two pieces of intermediate data obtained thus, and inverse frequency transformation processing is then performed for the intermediate data that underwent synthesis by decompression processing section 37 to produce non-compressed audio data.

### TECHNICAL FIELD

The present invention relates to an apparatus and method for processing compressed data, and a program for processing compressed data, that perform processing to synthesize together a plurality of compressed data.

### BACKGROUND ART

Conventionally, a plurality of sounds are used in computer game devices in accordance with the progress of a story or the contents of the operation of a player. For example, after the voice of a player character or an enemy character or the like is generated at an arbitrary timing in addition to various sound effects, the sounds are synthesized and output from one or a plurality of speakers.

Further, in a so-called “voice chat device” in which a plurality of users are connected through a network and conduct a conversation, a voice transmitted from the terminal device of one interlocutor is synthesized and distributed to the terminal devices of the other interlocutors.

However, when compressed audio data is considered as the data to be synthesized in the above-described conventional computer game devices and voice chat devices, a problem exists in that the compressed audio data that is generated or input is initially subjected to decompression processing before synthesis processing is performed, and thus the processing operations are burdensome and it is difficult to enhance the processing speed.

For example, in the aforementioned computer game devices, since various types of recorded compressed audio data are read out according to a predetermined generation timing and individually undergo decompression processing before being synthesized, when the number of pieces of compressed audio data to undergo synthesis increases, there is a significant increase in the throughput of decompression processing to be concurrently performed. Therefore, the processing time required from generation of compressed audio data to output of a synthesized sound increases in accordance with the increase in throughput.

Further, in the aforementioned voice chat devices, when compressed audio data is transmitted from the terminal device of individual interlocutors, it is necessary to initially decompress the compressed audio data of each interlocutor other than an interlocutor sending the data and then recompress the data again after performing synthesis, in correspondence with the number of interlocutors that are recipients. Thus, after performing decompression processing for compressed audio data corresponding to all the interlocutors, it is ultimately necessary to conduct different compression processing for each interlocutor. Accordingly, when the number of interlocutors increases, the processing load from the time of input of the proportionately increased amount of compressed audio data to output to each interlocutor of compressed audio data after synthesis becomes burdensome, and the time required for processing increases.

### DISCLOSURE OF THE INVENTION

The present invention has been created in consideration of the above points. It is an object of the present invention to provide a compressed data processing apparatus and method as well as a compressed data processing program that enable reduction of a processing load and enhanced processing speed.

The compressed data processing apparatus of the present invention comprises a compressed data acquisition unit into which is input compressed data for which restoration of data is performed by conducting a first and a second decompression processing, and which acquires a plurality of compressed data to undergo synthesis; a plurality of first decompression processing units that perform a first decompression processing with respect to each of a plurality of compressed data acquired by the compressed data acquisition unit; and a synthesis unit that synthesizes a plurality of intermediate data that were decompressed by the plurality of first decompression processing units. When performing synthesis processing for a plurality of compressed data, instead of performing synthesis processing after performing a first and second decompression processing to obtain non-compressed data, synthesis processing is performed using intermediate data obtained upon completion of only the first decompression processing. Therefore, the subsequent processing need only be performed for the intermediate data that has undergone synthesis instead of for each compressed data, to thereby enable the processing load to be reduced and an accompanying enhancement of the processing speed.

Preferably, the compressed data processing apparatus further comprises a second decompression processing unit that performs a second decompression processing for intermediate data output from the said synthesis unit. By performing the second decompression processing with respect to intermediate data that has undergone synthesis, it is possible to reduce the processing load required to obtain synthesized decompressed data (non-compressed data) and also to enhance the processing speed.

Further, the compressed data processing apparatus preferably comprises a compression processing unit that performs compression processing as inverse transformation of the first decompression processing with respect to intermediate data output from the said synthesis unit. By performing compression processing with respect to intermediate data that has undergone synthesis, it is possible to reduce the processing load required to synthesize together a plurality of compressed data and obtain compressed data again and also to enhance the processing speed.

Preferably, the compressed data processing apparatus further comprises a weight assignment processing unit that performs weight assignment processing for a plurality of intermediate data, and that is provided at a stage prior to the said synthesis unit. By performing weight assignment processing for each intermediate data prior to synthesis processing, it is possible to conduct balance control or the like with respect to each compressed data. In other words, even when carrying out balance control, it is possible to reduce the processing load after synthesis and enhance the processing speed.

Further, the compressed data processing apparatus of the present invention comprises a compressed data acquisition unit into which is input compressed data for which restoration of data is performed by conducting a third decompression processing, and which acquires a plurality of compressed data to undergo synthesis; a synthesis unit that synthesizes a plurality of compressed data that was acquired by the compressed data acquisition unit; and a third decompression processing unit that performs a third decompression processing with respect to compressed data that has undergone synthesis that is output from the synthesis unit. When performing synthesis processing for a plurality of compressed data, instead of performing synthesis processing after performing a third decompression processing to obtain non-compressed data, synthesis processing is carried out using compressed data before carrying out the third decompression processing. Therefore, the subsequent processing need only be carried out for the data that has undergone synthesis instead of for each compressed data, thereby enabling the processing load to be reduced and an accompanying enhancement of the processing speed.

The said compressed data is preferably compressed audio data. In general, the concept of synthesis is definable for audio data, and thus simplification of processing according to the present invention is possible.

The said compressed data is preferably compressed audio data and the weight assignment processing is preferably volume balance control processing. While there are many uses in which predetermined volume balance control (volume control) is carried out with respect to a plurality of sounds, in conventional audio synthesis processing, compressed sound undergoes balance control after it has been restored to non-compressed data. In the present invention, the data obtained after performing this volume balance control for intermediate data is synthesized, so that even in a case that requires volume balance control it is possible to reduce the processing load and enhance the processing speed.

Preferably, the said compressed data is compressed audio data in MPEG-1 audio format, and audio data of each of a plurality of frequency bands is decompressed by means of a first decompression processing, and inverse frequency transformation is carried out using audio data of each of a plurality of frequency bands by means of a second decompression processing. When using compressed audio data in MPEG-1 audio format, it is possible to perform synthesis using intermediate data that is decompressed audio data of each frequency band that underwent inverse quantization processing, to thereby enable the number of times that inverse frequency transformation processing is performed thereafter to be reduced to allow reduction of the processing load and enhancement of processing speed.

Preferably, the said second decompression processing is processing that enables synthesis of separate pieces of data prior to processing equivalent to synthesis of separate pieces of data after processing, and the first decompression processing is processing that does not enable synthesis of separate pieces of data prior to processing equivalent to synthesis of separate pieces of data after processing. For compressed data that is decompressed by a first and second decompression processing fulfilling these conditions, the number of times second decompression processing is performed can be reduced to enable reduction of the processing load and enhancement of processing speed.

Further, a method of processing compressed data of the present invention is a method of processing compressed data of a compressed data processing apparatus comprising a compressed data acquisition unit that acquires a plurality of compressed data for which decompression of data is performed by means of a first and second decompression processing, a plurality of first decompression processing units that carry out the first decompression processing for each of the plurality of compressed data acquired by the compressed data acquisition unit, and a synthesis unit that synthesizes a plurality of intermediate data that were decompressed by the plurality of first decompression processing units, wherein the method comprises a step of acquiring a plurality of compressed data by means of the compressed data acquisition unit, a step of performing a first decompression processing for each of the acquired plurality of compressed data by means of the first decompression processing units, and a step of performing synthesis processing by means of the synthesis unit using a plurality of intermediate data that is obtained after completion of the first decompression processing. When performing synthesis processing for a plurality of compressed data, instead of performing synthesis processing after performing a first and a second decompression processing to obtain non-compressed data, synthesis processing is performed using intermediate data obtained upon completion of only the first decompression processing. Therefore, the subsequent processing need only be performed for the intermediate data that has undergone synthesis instead of being performed for each compressed data, thereby enabling the processing load to be reduced and an accompanying enhancement of the processing speed.

When the compressed data processing apparatus has a second decompression processing unit that carries out a second decompression processing, preferably the said method further includes a step of performing a second decompression processing by means of the second decompression processing unit with respect to intermediate data output from the said synthesis unit. By performing the step of second decompression processing with respect to intermediate data that has undergone synthesis, it is possible to reduce the processing load required to obtain synthesized decompressed data (non-compressed data) and to enhance the processing speed.

Further, when the compressed data processing apparatus has a compression processing unit that performs compression processing that acts to inversely transform the first decompression processing, preferably the said method further includes a step of performing compression processing by means of the compression processing unit with respect to intermediate data output from the synthesis unit. By carrying out a step of conducting compression processing with respect to intermediate data that has undergone synthesis, it is possible to reduce the processing load required to obtain compressed data that consists of a plurality of compressed data that were synthesized together and then compressed again, and also to enhance the processing speed.

The compressed data processing program of the present invention is a program that, in order to synthesize a plurality of compressed data, makes a computer function as a compressed data acquisition unit that acquires a plurality of compressed data for which decompression of data is performed by conducting a first and a second decompression processing, a plurality of first decompression processing units that perform the first decompression processing with respect to each of a plurality of compressed data acquired by the compressed data acquisition unit, and a synthesis unit that synthesizes a plurality of intermediate data that were decompressed by the plurality of first decompression processing units. Through implementation of this compressed data processing program by a computer, it is possible to simplify processing performed for intermediate data that has undergone synthesis, to thereby enable reduction of the processing load and an accompanying enhancement of the processing speed.

Preferably, the said compressed data processing program makes a computer further function as a second decompression processing unit that conducts a second decompression processing for intermediate data output from the synthesis unit. By implementing this program it is possible to perform the second decompression processing for intermediate data that has undergone synthesis, thus enabling a reduction of the processing load required to obtain synthesized decompressed data (non-compressed data) and enhancement of the processing speed.

Further, the said compressed data processing program preferably makes a computer also function as a compression processing unit that performs compression processing that serves as inverse transformation of the first decompression processing with respect intermediate data output from the synthesis unit. By implementing this program it is possible to perform compression processing for intermediate data that has undergone synthesis, thus enabling a reduction of the processing load required to obtain compressed data consisting of a plurality of compressed data that were synthesized together and compressed again, and to enhance the processing speed.

### BRIEF DESCRIPTION OF THE DRAWINGS

FIG. 1 is a view showing the configuration of the compressed data processing apparatus of the first embodiment herein;

FIG. 2 is a view showing the detailed configuration of a multitrack decompression apparatus;

FIG. 3 illustrates a summary of decompression processing performed to obtain non-compressed audio data from compressed audio data;

FIG. 4 illustrates a summary of decompression and synthesis processing when synthesizing two pieces of data after the mth stage of sectional decompression processing;

FIG. 5 is a flowchart showing the details of a common decompression processing performed to restore compressed audio data in MPEG-1 audio format to non-compressed audio data;

FIG. 6 is a view showing the format of a frame of the MPEG-1 audio format;

FIG. 7 is a view showing a modified example of a multitrack decompression apparatus;

FIG. 8 is a flowchart showing the operations sequence of the multitrack decompression apparatus shown in FIG. 7;

FIG. 9 is a view showing the configuration of a compressed audio data synthesis apparatus as a second embodiment of the compressed data processing apparatus; and

FIG. 10 is a view showing the operations sequence in the case where the compressed audio data synthesis apparatus as the second embodiment is implemented according to the configuration shown in FIG. 7.

### BEST MODE FOR CARRYING OUT THE INVENTION

Hereunder, embodiments of a compressed data processing apparatus to which the present invention is applied are explained in detail referring to the drawings.

### First Embodiment

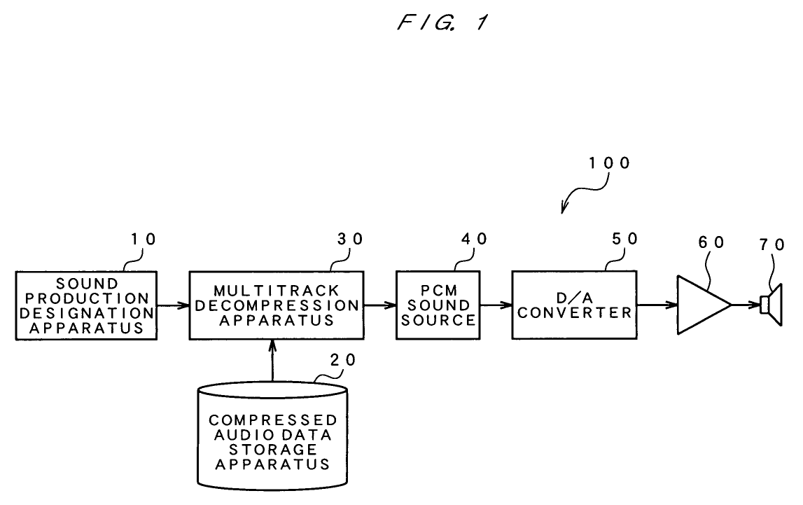

FIG. 1 is a view showing the configuration of a compressed data processing apparatus of the first embodiment. A compressed data processing apparatus 100 of this embodiment shown in FIG. 1, for example, constitutes one part of a game device or the like, and synthesizes and outputs a plurality of sounds at a predetermined timing for sound production. Therefore, the compressed data processing apparatus 100 comprises a sound production designating apparatus 10, a compressed audio data storage apparatus 20, a multitrack decompression apparatus 30, a PCM sound source 40, a D/A (digital-to-analog) converter 50, an amplifier 60 and a speaker 70.

The sound production designating apparatus 10 designates the compressed audio data to be read out and the readout timing. The compressed audio data storage apparatus 20 is an apparatus for storing compressed audio data that is an object of a readout operation and, for example, a semiconductor memory, hard disk device or optical disk device or the like may be used. The multitrack decompression apparatus 30 performs synthesis processing and decompression processing for a plurality of compressed audio data read out from the compressed audio data storage apparatus 20 to output decompressed audio data (non-compressed audio data). The PCM sound source 40 carries out a predetermined format conversion based on audio data output from the multitrack decompression apparatus 30 to output PCM data of a predetermined number of bits. The D/A converter 50 converts the PCM data to an analog audio signal, and this audio signal is amplified by the amplifier 60 and output from the speaker 70. Although FIG. 1 shows a sound reproduction system comprising one line, for example, when reproducing audio sound in stereo, the section of the system from the PCM sound source 40 to the speaker 70 can comprise a configuration used as an L-channel corresponding to left-side audio sound and a configuration used as an R-channel corresponding to right-side audio sound.

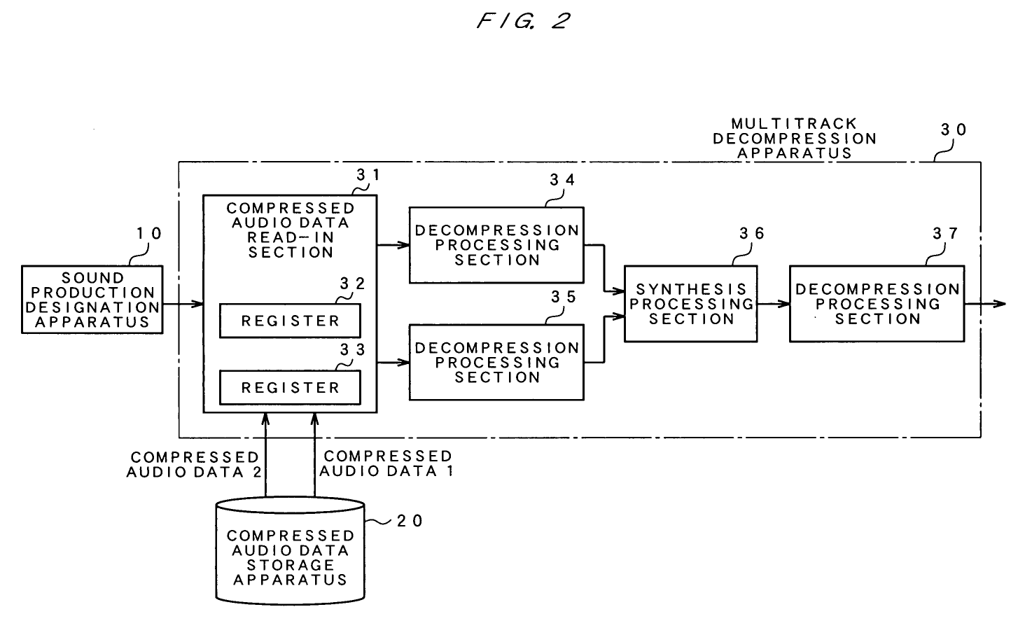

FIG. 2 is a view showing the detailed configuration of a multitrack decompression apparatus 30. As shown in FIG. 2, a multitrack decompression apparatus 30 comprises a compressed audio data read-in section 31, decompression processing sections 34, 35 and 37, and a synthesis processing section 36. For example, in this embodiment a case is taken in which two pieces of compressed audio data are read-in and subjected to synthesis. Further, the compressed audio data is taken as data that is compressed using the MPEG-1 (Moving Picture Experts Group 1) audio format compression technology.

In accordance with a readout instruction from the sound production designating apparatus 10, the compressed audio data read-in section 31 reads out two pieces of compressed audio data as specified and stores them in registers 32 and 33. Compressed audio data stored in the register 32 is input into the decompression processing section 34, and compressed audio data stored in the other register, register 33, is input into the other decompression processing section, decompression processing section 35.

The decompression processing section 34 carries out a first decompression processing for the input compressed audio data in MPEG-1 audio format. Likewise, the decompression processing section 35 also carries out a first decompression processing for the input compressed audio data in MPEG-1 audio format. Intermediate data is obtained by this first decompression processing.

The synthesis processing section 36 synthesizes the intermediate data that is output respectively from the two decompression processing sections 34 and 35. In the case of MPEG-1 audio, this synthesis processing is performed by adding together data of identical bands of each intermediate data. The decompression processing section 37 performs a second decompression processing for intermediate data after the intermediate data has been synthesized by the synthesis processing section 36. Non-compressed audio data is thus obtained through this second decompression processing.

The above compressed audio data read-in section 31 corresponds to a compressed data acquisition unit, the decompression processing sections 34 and 35 correspond to first decompression processing units, the synthesis processing section 36 corresponds to a synthesis unit, and the decompression processing section 37 corresponds to a second decompression processing unit, respectively.

Next, the contents of the above-described first and second decompression processing will be explained.

If the character F is used to denote decompression processing that is performed to convert input data denoted by “a” into output data denoted by “a′” and input data denoted by “b” into output data denoted by “b′”, this relationship can be represented as: a′=F(a), b′=F(b).

In this specification, if processing that synthesizes these two output data a′ and b′ is represented as a′-b′, in order to obtain non-compressed data after synthesis based on the two pieces of input data a and b, it is necessary to perform decompression processing F twice and to perform synthesis processing once.

However, if it is possible to synthesis two pieces of input data prior to decompression processing instead of synthesizing two pieces of non-compressed data after decompression processing, it will be possible to obtain the same output data by performing the subsequent decompression processing only once, thereby enabling simplification of procedures, reduction of processing load, shortening of processing time and the like. In this specification, processing that synthesizes two pieces of input data a and b before decompression is represented as a*b.

In order to enable the above-described synthesis of data after decompression processing to be performed prior to decompression processing, the following relationship must be fulfilled:
a′·b′=F(a*b) (1).
It is not necessary for the contents of the two kinds of synthesis processing represented by “·” and “*” to be identical. For example, when the synthesis processing represented by “·” is simple addition processing, the synthesis processing represented by “*” may be not only simple addition processing of the same contents as “·”, and may be a different type of processing such as multiplication or the like.

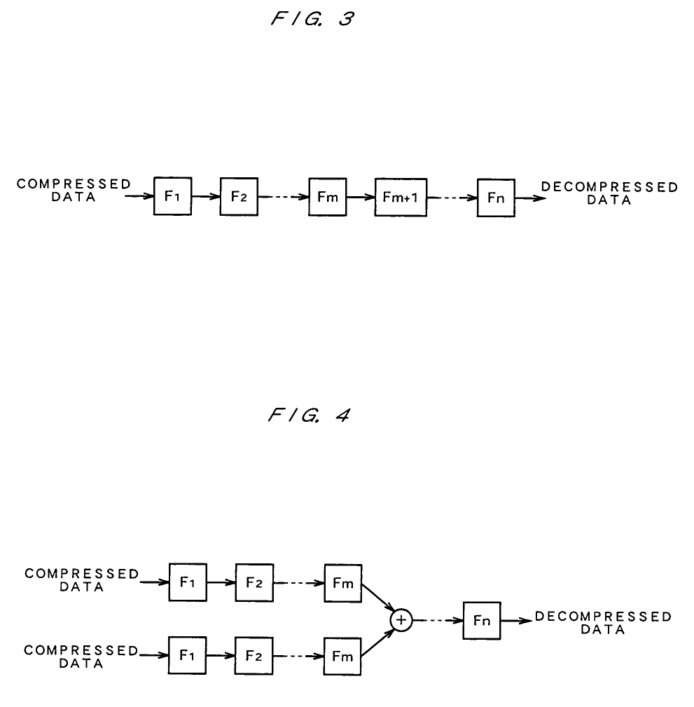

FIG. 3 illustrates a summary of decompression processing performed to obtain non-compressed audio data from compressed audio data. As shown in FIG. 3, decompression processing is commonly broken down into sectional decompression processing operations of n stages represented by F₁, F₂, . . . Fn. Here, n is an integer of 1 or greater, and although in decompression processing using the simplest processing and having a low compression ratio there are cases where n is 1, in practical decompression processing having a relatively high compression ratio n is usually 2 or greater.

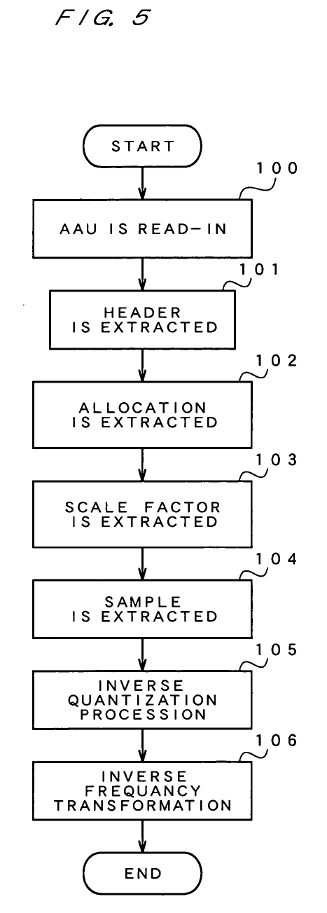

In this connection, when considering a model in which a plurality of sectional decompression processing operations F₁, F₂, . . . Fₙ are connected in series as shown in FIG. 3, when synthesis processing G having the sectional decompression processing operations from the m+1th stage onward fulfills the relation in formula (1) (the relation shown by a′·b′=G(a*b), where F in formula (1) is replaced by G. In this formula a and b are the input data of synthesis processing G, which are output as intermediate data from Fₘ, the mth stage of the sectional decompression processing.), by performing the sectional decompression processing operations from the m+1th stage onward with respect to the synthesized intermediate data obtained after synthesis of the intermediate data obtained by the mth stage of the sectional decompression processing, a result is obtained that is the same as the result obtained by ultimately synthesizing non-compressed audio data after performing the sectional decompression processing of n stages for each of two pieces of compressed audio data. FIG. 4 illustrates a summary of decompression and synthesis processing when synthesizing two pieces of intermediate data after the mth stage of sectional decompression processing in this manner.

By synthesizing intermediate data output at an intermediate stage of decompression processing in the above manner, it is possible to commonly carry out the sectional decompression processing operations performed in the stages thereafter, thereby enabling simplification of the decompression processing. In this embodiment, the MPEG-1 audio system is adopted as compression and decompression processing that has such characteristics.

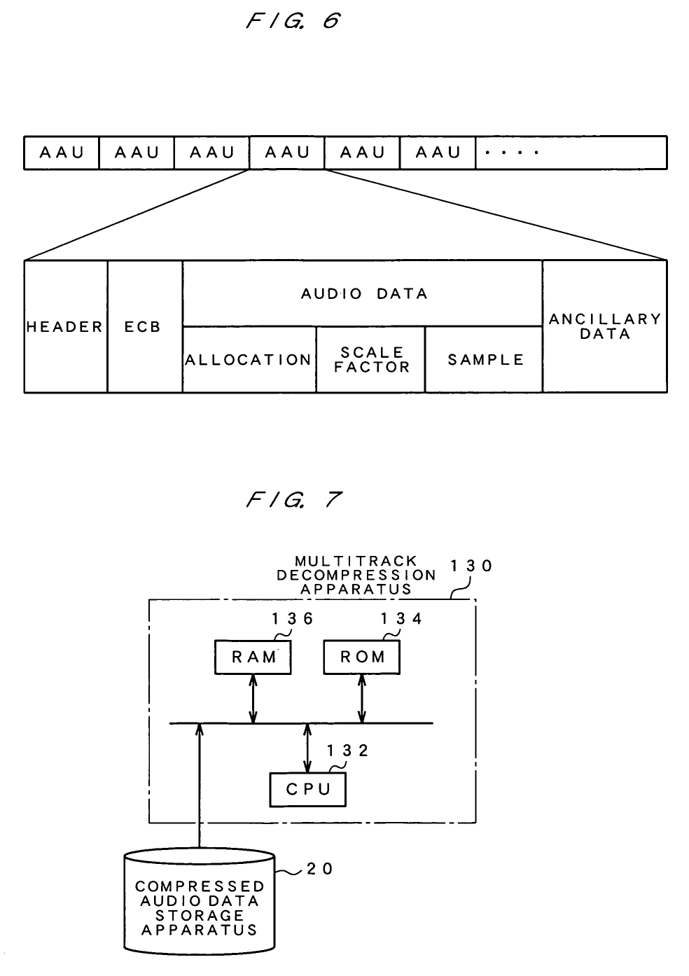

FIG. 5 is a flowchart showing the details of decompression processing commonly performed to restore compressed audio data in MPEG-1 audio format to non-compressed audio data. FIG. 6 is a view showing the format of a frame in the MPEG1 audio format.

As shown in FIG. 6, the MPEG audio bit stream of MPEG-1 audio format employs an AAU (Audio Access Unit) as a unit and is composed of a plurality of AAUs. An AAU is the minimum unit that can independently decode an audio signal. Each AAU is composed of a header, error check, audio data and ancillary data. Of these, audio data is composed of an allocation, scale factor and sample.

The header includes information that specifies a sync pattern and sampling rate, and decompression processing is conducted based on each of these pieces of information.

Audio data includes the actual compressed audio data. In the allocation inside the audio data the presence or absence of data in 32 subbands for 2 channels is coded. In practice, for low frequency components up to subbands separated by bounds, information of two channels is independently coded, and for high frequency components above those, the information of a common one channel is coded.

The scale factor shows the scaling factor at the time of reproduction of audio data for each subband and each channel. These are respectively represented by 6 bits, and can be specified in 2 dB units from +6 dB to −118 dB. This scale factor is omitted for subbands that are designated by 0 in the allocation.

The sample includes the actual waveform data in a frequency-converted form. The number of bits specified by the allocation is allocated for each sample.

When performing decompression processing of compressed audio data using an MPEG audio bit stream having the aforementioned frame format, an AAU is read-in as a compression frame (step 100) as a unit of the decompression processing, the header is extracted from the AUU that was read-in (step 101), and thereafter the allocation, scale factor and sample are respectively extracted (steps 102, 103 and 104). Next, inverse quantization processing is performed based on the extracted allocation, scale factor and sample (step 105) to reproduce the data of each of the 32 subbands. Subsequently, inverse frequency transformation is performed (step 106) to convert the data of each frequency component to waveform data of each time. Thus, a series of decompression processing for compressed audio data is completed.

When considering the case of two pieces of compressed audio data in decompression processing that corresponds to MPEG-1 audio, the inverse frequency transformation processing of step 106 fulfills the relation of the above formula (1). More specifically, it is possible to synthesize two pieces of intermediate data in a step prior to the inverse frequency transformation processing of step 106. In the multitrack decompression apparatus 30 of this embodiment illustrated in FIG. 2, the first decompression processing operations up to the inverse quantization processing of step 105 are performed by the decompression processing sections 34 and 35 of the preceding stage to output intermediate data, and for the data obtained after synthesis of two pieces of intermediate data, the second decompression processing operations after the inverse frequency transformation processing of step 106 are performed by the decompression processing section 37 of the subsequent stage to output non-compressed audio data.

Thus, for the compressed data processing apparatus 100 of this embodiment, in the multitrack decompression apparatus 30 the first decompression processing operations are performed separately for two pieces of compressed data in MPEG-1 audio format up to a step of inverse quantization processing to obtain intermediate data, and the second decompression processing operations from the inverse frequency transformation processing onward are performed with respect to data obtained after synthesis of these two pieces of intermediate data. Accordingly, compared to a case where a first and second decompression processing are performed separately for each piece of compressed audio data and the data is synthesized after being restored to non-compressed audio data, the number of second decompression processing operations can be reduced to enable a reduction in the processing load and enhancement of processing speed.

Conceivable uses of the above-described compressed data processing apparatus 100 of this embodiment are described in (1) to (3) below.

(1) Game Device

In game devices, it is necessary to produce a variety of sound effects or voices of player characters or enemy characters or the like at the appropriate timing in accordance with the progress of a game or contents of operation of a player. Synthesis is enabled when the headers of the specific unit (for MPEG-1 audio, the unit is AAU) of a plurality of sounds match, and the above-described compressed data processing apparatus 100 can be used for production of synthesized sounds at this time. Thus, it is possible to reduce the processing load from a step of reading-out compressed audio data corresponding to two or more sounds to a step of ultimately outputting the synthesized sounds. In particular, as the number of sounds that are the object of synthesis increases, the effect of reducing the load of the second decompression processing after synthesis processing increases.

(2) Multichannel Sound Source

In a multichannel sound source that synthesizes and outputs sounds of a plurality of tracks, it is necessary to perform decompression processing concurrently for a plurality of compressed audio data that is read out from one music source or for a plurality of compressed audio data that is read out from a plurality of music sources. Therefore, a decompression processing load is large. By using the above-described compressed data processing apparatus 100 in a multichannel sound source, the load of processing corresponding to the second decompression processing can be greatly reduced.

(3) Cross-Fade Device

A cross-fade device is a device that simultaneously performs so-called “fade-out” processing, in which the output volume of a sound being output is gradually lowered, and so-called “fade-in” processing, in which the output volume of a different sound is gradually increased. By using the above-described compressed data processing apparatus 100 in processing to synthesize the sound that is the object of fade-out processing and the sound that is the object of fade-in processing, the load of processing corresponding to the second decompression processing can be greatly reduced.

Although the multitrack decompression apparatus 30 of this embodiment can be configured using purpose-built hardware, it can also be configured using a general purpose computer such as a personal computer or an apparatus having equivalent functions thereto.

FIG. 7 is a view illustrating a modified example of the multitrack decompression apparatus. The multitrack decompression apparatus 130 illustrated in FIG. 7 comprises a CPU 132, a ROM 134 and a RAM 136. By implementing a program stored in the ROM 134 or RAM 136 using the CPU 132, the apparatus can operate as a computer that performs substantially the same processing as the multitrack decompression apparatus 30 illustrated in FIG. 2. If the operations to designate the timing of sound production that are performed by the sound production designating apparatus 10 shown in FIG. 2 are also performed by implementation of a program using the CPU 132, the sound production designating apparatus 10 can be omitted from the configuration.

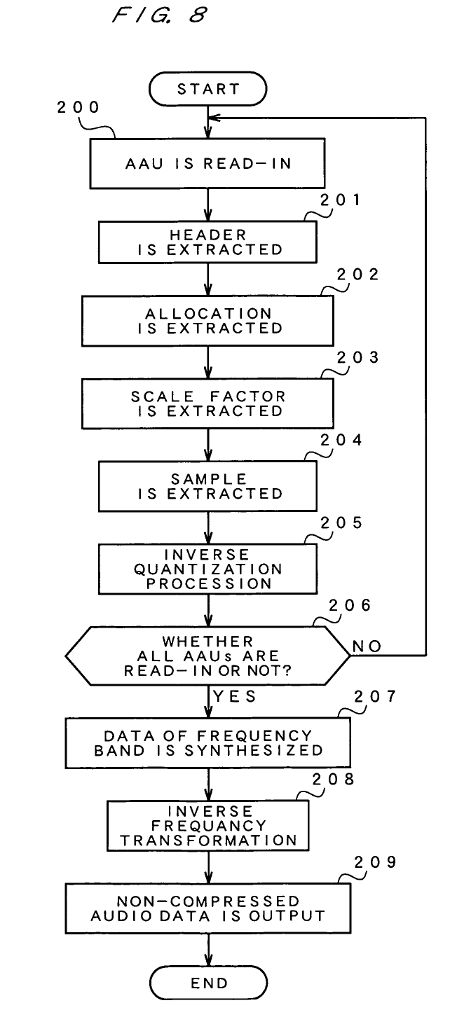

FIG. 8 is a flowchart showing the sequence of operations of the multitrack decompression apparatus 130 shown in FIG. 7. The flowchart shows the sequence of operations performed by implementation by the CPU 132 of a compressed data processing program that is stored in the ROM 134 or the RAM 136.

At a predetermined timing for sound production, the CPU 132 reads-in an AAU as a compressed frame in MPEG-1 audio format that corresponds to one piece of compressed audio data as an object of synthesis (step 200). Next, the CPU 132 extracts the header from the AAU that was read-in (step 201) and then respectively extracts the allocation, scale factor, and sample (steps 202, 203 and 204), and based thereon carries out inverse quantization processing (step 205).

Next, the CPU 132 judges whether read-in of all AAUs to be subject to synthesis has been completed (step 206). For example, when performing synthesis of two pieces of compressed audio data, if only the read-in of AAUs corresponding to one piece of compressed audio data is completed and the read-in of AAUs corresponding to the other piece of compressed audio data is not completed, a negative judgment is made in the judgment at step 206, and the processing from the aforementioned step 200 onward is repeated for the other AAUs.

When the read-in of all AAUs to be subject to synthesis is completed, an affirmative judgment is made in the judgment at step 206, and the CPU 132 then performs synthesis processing of data of each subband for the two pieces of compressed audio data (step 207). This synthesis processing is performed by creating band data of synthesized intermediate data by adding together identical bands with respect to the band data of each intermediate data. Next, the CPU 132 carries out inverse frequency transformation processing with respect to the data that has undergone synthesis (step 208), and outputs non-compressed audio data that has undergone synthesis (step 209).

Thus, in the multitrack decompression apparatus 130, since synthesis processing is performed after separately carrying out the steps up to inverse quantization processing for each of two pieces of compressed audio data, and the subsequent inverse frequency transformation processing is performed commonly, it is possible to reduce the processing load of the overall decompression processing and enhance the processing speed.

### Second Embodiment

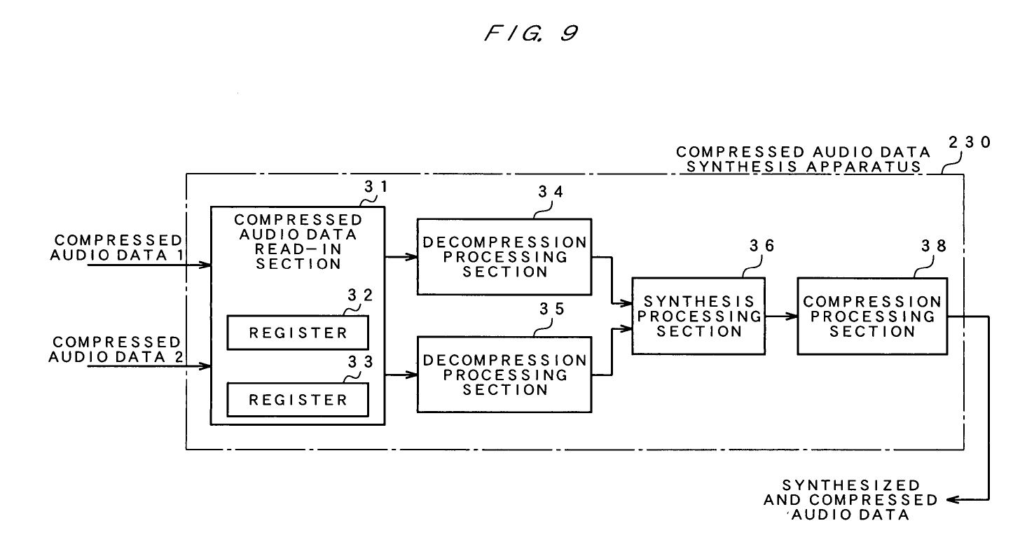

FIG. 9 is a view showing the configuration of a compressed audio data synthesis apparatus as a second embodiment of the compressed data processing apparatus. As shown in FIG. 9, the compressed data synthesis apparatus 230 comprises a compressed audio data read-in section 31, decompression processing sections 34 and 35, a synthesis processing section 36, and a compression processing section 38. For example, in this embodiment two pieces of compressed audio data are read-in and then subjected to synthesis, and the data that has undergone synthesis is compressed again and output. In FIG. 9, components that perform fundamentally the same operation as components comprised by the multitrack decompression apparatus 30 in FIG. 2 have been assigned the same symbols as those corresponding components, and a detailed description of the components is omitted herein.

The compression processing section 38 performs compression processing for intermediate data output from the synthesis processing section 36 that is the opposite of the decompression processing performed by the decompression processing sections 34 and 35. Further, the synthesis processing section 38 decides a masking level for each band, and performs band deletion processing that deletes band data that is below the masking level. When an AAU is read out in the synthesis processing section 36, the allocation, scale factor, and sample are extracted based on the extracted header and inverse quantization processing is then conducted to obtain the data of each subband, therefore, in the compression processing section 38, compression processing is performed that is the reverse of these processes, that is, band deletion processing and quantization processing is carried out using data of each subband and thereafter an allocation, scale factor, sample and header are created to create an AAU. An AAU created in this manner by the compression processing section 38 is output from the compressed audio data synthesis apparatus 230. The above-described compression processing section 38 corresponds to a compression processing unit.

Similarly to the first embodiment described above, the compressed audio data synthesis apparatus 230 of this embodiment can be configured using purpose-built hardware, or it can be configured using a general purpose computer such as a personal computer or an apparatus having equivalent functions thereto. For example, a compressed audio data synthesis apparatus can be configured using a configuration that is exactly the same as that of the multitrack decompression apparatus 130 illustrated in FIG. 7.

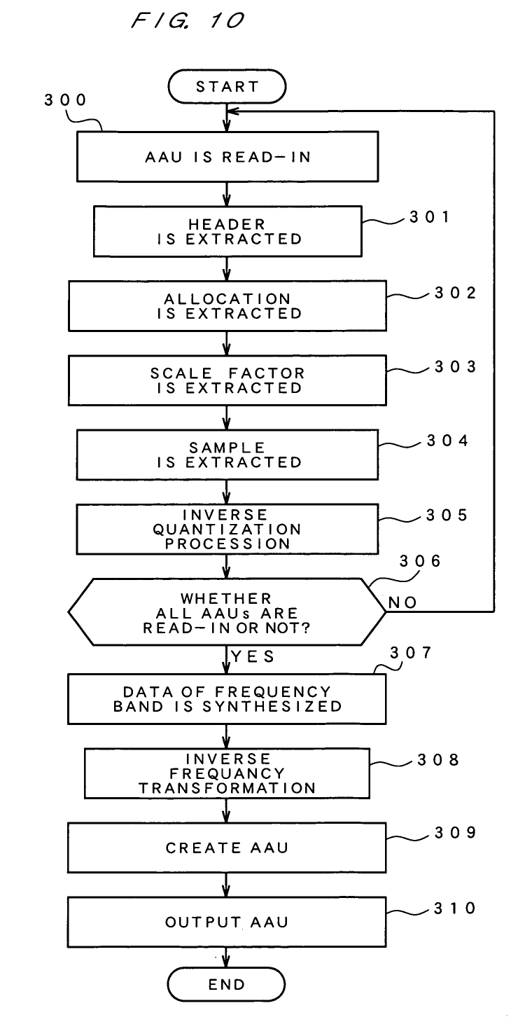

FIG. 10 is a view showing the operations sequence in a case where the compressed audio data synthesis apparatus of this embodiment is implemented according to the configuration shown in FIG. 7. FIG. 10 shows the sequence of operations performed by implementation by the CPU 132 of a compressed audio data synthesis program stored in the ROM 134 or the RAM 136. The processing operations in each of steps 300 to 307 shown in FIG. 10 are fundamentally the same as the processing operations in each of steps 200 to 207 shown in FIG. 8, and therefore a detailed description is omitted herein.

In step 307, after synthesis processing of data in each subband is completed, the CPU 132 conducts quantization processing using the synthesized data of each subband (step 308), and then carries out processing to create an AAU comprising an allocation, scale factor, sample, header and the like (step 309), and subsequently outputs the created AAU (step 310).

Thus, in the compressed audio data synthesis apparatus of this embodiment, first decompression processing up to a step of inverse quantization processing is carried out separately for two pieces of compressed data in MPEG-1 audio format to obtain intermediate data, and without subsequently carrying out decompression processing, the data obtained as a result of synthesizing these two pieces of intermediate data is subjected to compression processing. Accordingly, since the procedures of a subsequent decompression processing and a compression processing corresponding to the decompression processing can be omitted, it is possible to reduce the processing load and enhance the processing speed.

Conceivable uses of the above-described compressed audio data synthesis apparatus 230 of this embodiment are described in (4) to (6) below.

(4) Audio Mixer

In a conventional audio mixer that performs synthesis processing for an inputted plurality of compressed audio data and outputs the data obtained as a result of synthesis as compressed data, the inputted compressed audio data is initially subjected to decompression processing to obtain completely non-compressed data, after which it is synthesized, and then undergoes compression processing again. Specifically, in a conventional audio mixer it is necessary to perform complete decompression processing a number of times that corresponds to the number of input compressed audio data, and after synthesizing the non-compressed data obtained by these decompression processing operations, to then perform complete compression processing. Thus, the processing load is large. By using the above compressed audio data synthesis apparatus 230 in this kind of audio mixer, one part of the decompression processing and one part of the compression processing can be omitted, thereby enabling a large reduction in the processing load.

(5) Voice Chat Server

In a voice chat server to which a plurality of users are connected through a network to carry out a conversation, it is necessary to synthesize compressed audio data sent from a terminal of each user and send the synthesized data back to the terminal of each user. By performing this synthesis processing using the above described compressed audio data synthesis apparatus 230, the processing load can be reduced in comparison to the case of performing synthesis after completely decompressing the data to produce non-compressed data, and then re-compressing the synthesized data.

(6) Teleconference System

Similarly to a voice chat server, the above described compressed audio data synthesis apparatus 230 can be used when synthesizing together compressed audio data produced by collecting sound from microphones provided in conference rooms or the like in a plurality of locations. It is thereby possible to reduce the load of processing required to distribute the compressed audio data to each conference room or the like.

The present invention is not limited to the above embodiments, and various variations of the above embodiments are considered to fall within the scope of the invention. For example, while synthesis is carried out in each of the above embodiments without changing the respective volume levels when synthesizing two pieces of inputted compressed audio data, volume balance control may be performed prior to synthesis. This volume balance control can be conducted by providing the synthesis processing section 36 shown in FIG. 2 or FIG. 9 with a function as a weight assignment processing unit, or by providing a volume balance control section as a weight assignment processing unit at the stage prior to the synthesis processing section 36. Since intermediate data output from the decompression processing sections 34 and 35 is the data of each subband, when performing two volume balance control operations, processing may be carried out by multiplying the data of each subband by a predetermined multiplier. Further, when performing volume balance control in the multitrack decompression processing apparatus 130 having the configuration shown in FIG. 7 or a compressed audio data synthesis apparatus, a step that performs volume balance control may be added between the judgment processing of step 206 and the synthesis processing of step 207 in FIG. 8, or between the judgment processing of step 306 and the synthesis processing of step 307 in FIG. 10.

In each of the above embodiments synthesis processing is performed using intermediate data that has been subjected to predetermined decompression processing by decompression processing sections 34 and 35. However, for example, in a case where the compressed audio data itself can be synthesized (when the overall decompression processing fulfills the relation shown in formula (1)), such as compressed audio data in differential PCM (DPCM) format, the decompression processing sections 34 and 35 shown in FIG. 2 and FIG. 9 can be omitted, and two pieces of compressed audio data may be directly input into the synthesis processing section 36. In this case, the decompression processing section 37 provided in the stage after the synthesis processing section 36 in FIG. 2 performs decompression processing to obtain non-compressed audio data based on the compressed audio data. The decompression processing section 37 in this case corresponds to a third decompression processing unit.

### INDUSTRIAL APPLICABILITY

As described above, according to the present invention, when performing synthesis processing for a plurality of compressed data, instead of performing synthesis processing after performing a first and a second decompression processing to obtain non-compressed data, the synthesis processing is performed using intermediate data obtained upon completion of only the first decompression processing. Thus, instead of performing the subsequent processing for each compressed data, the processing need only be performed for the intermediate data that has undergone synthesis, thus enabling a reduction in the processing load and an accompanying enhancement of the processing speed.

1. A compressed data processing apparatus into which is input compressed data for which data restoration is performed by carrying out a first and a second decompression processing, the compressed data processing apparatus comprising:
a compressed data acquisition unit that acquires a plurality of the compressed data as an object for synthesis, a plurality of first decompression processing units that perform the first decompression processing with respect to each of the plurality of compressed data acquired by the compressed data acquisition unit; and
a synthesis unit that synthesizes a plurality of intermediate data that were decompressed by the plurality of first decompression processing units.

2. The compressed data processing apparatus according to claim 1, which further comprises a second decompression processing unit that performs the second decompression processing with respect to intermediate data output from the synthesis unit.

3. The compressed data processing apparatus according to claim 1, which further comprises a compression processing unit that performs compression processing as inverse transformation of the first decompression processing with respect to intermediate data output from the synthesis unit.

4. The compressed data processing apparatus according to claim 1, which further comprises a weight assignment processing unit that is provided at a stage prior to the synthesis unit and carries out weight assignment processing with respect to the plurality of intermediate data.

5. The compressed data processing apparatus according to claim 1, wherein the compressed data is compressed audio data.

6. The compressed data processing apparatus according to claim 4, wherein the compressed data is compressed audio data and the weight assignment processing is volume balance control processing.

7. The compressed data processing apparatus according to claim 1, wherein the compressed data is compressed audio data in MPEG-1 audio format, audio data of each of a plurality of frequency bands is decompressed by the first decompression processing, and inverse frequency transformation is performed using the audio data of each of the plurality of frequency bands by the second decompression processing.

8. The compressed data processing apparatus according to claim 1, wherein the second decompression processing is processing that enables synthesis together of data prior to processing equivalent to synthesis together of data after processing, and
the first decompression processing is processing that does not enable synthesis together of data prior to processing equivalent to synthesis together of data after processing.

9. A compressed data processing apparatus into which is input compressed data for which data restoration is performed by carrying out a third decompression processing, characterized in that the compressed data processing apparatus comprises a compressed data acquisition unit that acquires a plurality of the compressed data as an object for synthesis, a synthesis unit that synthesizes the plurality of compressed data acquired by the compressed data acquisition unit, and a third decompression processing unit that performs the third decompression processing for compressed data that has undergone synthesis that is output from the synthesis unit.

10. The compressed data processing apparatus according to claim 9, wherein the compressed data is compressed audio data.

11. A compressed data processing method of a compressed data processing apparatus comprising a compressed data acquisition unit that acquires a plurality of compressed data for which data restoration is carried out by performing a first and a second decompression processing, a plurality of first decompression processing units that perform the first decompression processing for each of the plurality of compressed data acquired by the compressed data acquisition unit, and a synthesis unit that synthesizes a plurality of intermediate data that were decompressed by the plurality of first decompression processing units, the method comprising the steps of:
acquiring a plurality of compressed data by means of the compressed data acquisition unit;
performing the first decompression processing for each of the acquired plurality of compressed data by means of the first decompression processing units; and
performing synthesis processing by means of the synthesis unit using a plurality of intermediate data that are obtained upon completion of the first decompression processing.

12. The method for processing compressed data according to claim 11, wherein the compressed data processing apparatus has a second decompression processing unit that performs the second decompression processing, and
wherein the method further comprises a step of performing the second decompression processing by means of the second decompression processing unit with respect to the intermediate data output from the synthesis unit.

13. The method for processing compressed data according to claim 11, wherein the compressed data processing apparatus has a compression processing unit that performs compression processing as inverse transformation of the first decompression processing, and
wherein the method further comprises a step of performing the compression processing by means of the compression processing unit with respect to the intermediate data output from the synthesis unit.

14. A computer-readable program for processing compressed data for making a computer function as:
a compressed data acquisition unit that acquires a plurality of compressed data for which data restoration is performed by carrying out a first and a second decompression processing;
a plurality of first decompression processing units that perform the first decompression processing for each of the plurality of compressed data acquired by the compressed data acquisition unit; and
a synthesis unit that synthesizes a plurality of intermediate data that were decompressed by the plurality of first decompression processing units,
to synthesize a plurality of compressed data.

15. The computer-readable program for processing compressed data according to claim 14, which is a program for making the computer further function as a second decompression processing unit that performs the second decompression processing for intermediate data output from the synthesis unit.

16. The computer-readable program for processing compressed data according to claim 14, which is a program for making the computer further function as a compression processing unit that performs compression processing as inverse transformation of the first decompression processing with respect to intermediate data output from the synthesis unit.
